(19) United States
(12) Patent Application Publication
(10) Pub. No.: US 2018/0282506 A1
(43) Pub. Date: Oct. 4, 2018

(54) SELF BINDING NANO PARTICLE MINERAL PIGMENT

(71) Applicants: Prakash B. Malla, Dublin, GA (US); Siva Devisetti, Sandersville, GA (US)

(72) Inventors: Prakash B. Malla, Dublin, GA (US); Siva Devisetti, Sandersville, GA (US)

(21) Appl. No.: 16/002,370

(22) Filed: Jun. 7, 2018

Related U.S. Application Data
(63) Continuation-in-part of application No. 13/815,326, filed on Feb. 21, 2013.
Application No. 13/815,326 is a division of application No. 12/380,208, filed on Feb. 25, 2009, now Pat. No. 8,382,016.
Application No. 12/380,208 is a continuation-in-part of application No. 13/815,767, filed on Mar. 15, 2013, now abandoned.
Application No. 13/815,767 is a continuation-in-part of application No. 13/815,326, filed on Feb. 21, 2013.
Application No. 13/815,326 is a division of application No. 12/380,208, filed on Feb. 25, 2009, now Pat. No. 8,382,016.

(51) Int. Cl. C08K 3/34; B02C 23/18

(52) U.S. Cl. CPC C08K 3/346; C01P 2006/60; C01P 2006/12; D21H 19/40; B02C 23/18

(57) ABSTRACT

Self binding mineral pigments (such as kaolin clay) having a high surface area and particle size in the nano scale range are provided which are useful in paper coating and filling, ink jet coating formulations, paint compositions, and as a filler in rubbers, plastics and polymers. These self binding pigments are manufactured by intensive wet milling of a mineral composition which may optionally be subjected to intensive dry grinding and acid treatment prior to wet milling or an acid treatment following dry grinding and wet milling.

### CROSS REFERENCE TO RELATED APPLICATION

This application is:

(a) a continuation-in-part of, and claims the benefit of, U.S. Ser. No. 13/815,326, filed Feb. 21, 2013, a divisional of U.S. Ser. No. 12/380,208, filed Feb. 25, 2009, issued Feb. 26, 2013, as U.S. Pat. No. 8,382,016, and

(b) a continuation-in-part of, and claims the benefit of, U.S. Ser. No. 13/815,767, filed Mar. 15, 2013, a continuation-in-part of U.S. Ser. No. 13/815,326, filed Feb. 21, 2013, a divisional of U.S. Ser. No. 12/380,208, filed Feb. 25, 2009, issued Feb. 26, 2013, as U.S. Pat. No. 8,382,016,

each of which is incorporated herein by reference in its entirety.

### TECHNICAL FIELD

This invention relates to self binding mineral pigments. In a more specific aspect, this invention relates to self binding mineral pigments having a high surface area and a majority of particles with a particle size of less than 200 nanometers. This invention also relates to a process for the manufacture of these self binding mineral pigments.

This invention will be described in detail with specific reference to kaolin clay as the starting mineral composition. However, this invention will be understood as applicable to other starting mineral compositions, such as natural calcium carbonate, precipitated calcium carbonate, bentonite, calcium sulfate (also referred to as gypsum), zeolite, titanium dioxide, iron oxide, iron hydroxide, aluminum oxide and aluminum hydroxide.

### BACKGROUND OF THE INVENTION

Kaolin is a naturally occurring, relatively fine, white clay mineral which may be generally described as a hydrated aluminum silicate (Al₂O₃.2SiO₂.2H₂O). The structure of kaolin is principally one octahedral Al(OH)₃ sheet covalently bonded with one tetrahedral SiO₄ sheet to form a 1:1 layer. Ideally, this 1:1 layer is electrically neutral. Adjacent layers are held together primarily by hydrogen bonding between the basal oxygen atoms of the tetrahedral sheet and the hydroxyls of the surface plane of the adjacent octahedral sheet.

The ideal structural formula of kaolin can be represented as Al₂Si₂O₅(OH)₄. After purification and beneficiation, kaolin is widely used as a filler and pigment in various materials, such as rubber and resins, and in various coatings, such as paints and coatings for paper.

The use of kaolin in paper coatings serves, for example, to improve brightness, color, gloss, smoothness, opacity, printability and uniformity of appearance of the coated paper. As a filler in paper formulations, kaolin is used to extend fiber and reduce cost, and to improve opacity, brightness and other desirable characteristics of the filled paper product.

Kaolin clay is naturally hydrous and may contain as much as 13.95% water in the structure in the form of hydroxyl groups. Examples of hydrous kaolin clay are the products marketed by Thiele Kaolin Company (Sandersville, Ga.) under the trademarks KAOFINE 90 and KAOLUX. These products have not been subjected to a calcination step.

Calcined kaolin is another type of kaolin and is obtained by heating (i.e., calcining) beneficiated kaolin clay at temperatures of at least 550° C. The calcination step dehydroxylates and converts the kaolin into a noncrystalline aluminosilicate phase. (The term “dehydroxylates” refers to the removal of structural hydroxyl groups from the kaolin in the form of water vapor.) The smaller particles of the feed clay are aggregated by calcination, and this aggregation increases the original volume of the kaolin and gives the calcined kaolin a “fluffy” appearance. Particle aggregation increases the light scattering characteristics of the kaolin (as compared to non-calcined kaolin) and, therefore, contributes to a high degree of opacity and insulating properties to a coated paper.

In addition, calcination increases the brightness of kaolin. An example of calcined kaolin clay is the product marketed by Thiele Kaolin Company under the trademark KAOCAL. The high brightness of the calcined clay is partly due to the removal of organic material and partly due to the mobilization of the impurity phases in the amorphous network at elevated temperatures. The brightness can also be improved through pre-calcination beneficiation processes such as magnetic separation, froth flotation, selective flocculation and chemical leaching.

Both hydrous and calcined kaolin clay products are useful in coating compositions for conventional printing applications such as offset, rotogravure, letterpress and flexographic. However, without substantial mechanical and/or chemical modifications, conventional hydrous and calcined kaolin clay products are not useful in coating compositions for ink jet printing applications.

In an ink jet printing process, uniformly shaped tiny droplets of aqueous or solvent based dye solutions are ejected from a nozzle onto a substrate. There are two primary types of ink jet printing—continuous ink jet printing and drop on demand ink jet printing (DOD). The continuous ink jet is used in high speed printing such as addressing, personalization, coding and high resolution color printing such as proofing. The DOD ink jet is mainly used in home, office and wide format printing.

Common DOD ink jet printers are the thermal ink jet printer and the piezoelectric printer. In the thermal (or bubble jet) process, ink is heated and vaporized periodically with a heating element connected to the digital data to generate bubbles. Since the volume of the ink increases during vaporization, the ink is forced out of the nozzle in the form of a drop which is deposited on the paper.

In the piezoelectric process, the drop is generated by pressure using a piezoelectric crystal instead of heat as in the thermal method. The piezoelectric materials exhibit the “piezo-electric effect”; that is, the materials undergo distortion when an electric field is applied. The piezoelectric crystal mounted behind the nozzle expands and shrinks when an electrical pulse is applied, followed by displacement of drops from the nozzle. The piezoelectric printer has several advantages (e.g., a more controlled and higher rate of drop production and long head life) over the thermal printer.

Ink jet printing requires special paper for achieving high quality images due to the nature of the inks used and the design of the printhead. Most of these inks are anionic and principally consist of water and a water soluble solvent. Inks are jetted from a series of very small orifices, each approximately 10-70 μm in diameter, to specified positions on a media to create an image. Multipurpose plain paper is unsuitable for good quality ink jet printing since that type of paper causes numerous quality issues such as feathering, wicking, color bleeding, low color density, strike-through and cockle/curl. Consequently, ink jet papers are commonly coated with special ink receptive layers which are formulated to provide good print quality and adequate ink drying/absorption.

Amorphous silica (such as silica gel) is a commonly used pigment for the matte grade ink jet coating applications. The high surface area and porous silica pigment provides high porosity coatings for quick absorption of ink solvent and rapid ink drying time. However, silica gel is expensive and can only be made down at very low solids. For example, most silica gels can be made down at only 15-18% solids which may result in low coating solids.

Several non-silica based pigments for ink jet paper coating applications are known in the industry. For example, heat aged precipitated calcium carbonate is disclosed in Donigan et al. U.S. Pat. No. 5,643,631.

Chen et al. PCT International Publication No. WO 98/36029 and Chen et al. U.S. Pat. No. 6,150,289 disclose a coating composition comprising calcined clay, a cationic polymer, polyvinyl alcohol, a latex binder and optionally a cross-linking agent.

Londo et al. U.S. Pat. No. 5,997,625 discloses a coating composition comprising a fine particle hydrous clay, a caustic leached calcined clay and a porous mineral (zeolite).

Malla and Devisetti U.S. Pat. No. 6,610,136 discloses aggregated large particle size mineral pigments having a high surface area and low light scattering and useful in coating and filling compositions for ink jet printing media.

All of the above non-silica based pigments are primarily designed for matte grade ink jet coated paper. However, in most of the photographic and high end ink jet printing applications, a glossy coated paper is preferred. Currently, there are two types of glossy coatings: (1) a swellable polymer coating and (2) a microporous coating.

In a swellable polymer coating, the drying of ink is slow and involves diffusion of water molecules into the polymer matrix and swelling of the polymer matrix. Polymers such as polysaccharides (cellulose derivatives), gelatins, poly(vinyl alcohol), poly(vinyl pyrrolidone) and poly(ethylene oxide) are used in swellable coatings. On the other hand, ink drying is relatively fast in a microporous coating which occurs due to water absorption into the pore structures of the coating and base paper by capillary action. High surface area and very fine particle pigments such as alumina, aluminum hydroxides, fumed silica, and colloidal silica are the pigments of choice for glossy coatings.

Berube et al. U.S. Pat. No. 6,585,822 discloses the use of fine particle kaolin clay as a gloss coating on a paper pre-coated with a layer of a microporous ink jet coating pigment comprising a mixture of hydrous kaolin clay, caustic leached calcined kaolin clay and a zeolitic molecular sieve. The glossy pigment coating requires that the paper be pre-coated with a highly absorbent coating layer.

The above mentioned pigments can be very expensive, difficult to handle or do not meet the performance requirements. Thus, there is a need in the industry for a cost effective mineral pigment that meets the performance requirements for glossy ink jet printing applications.

Binders are adhesives which, in conventional pigment formulations, hold the pigment particles together and also bond the coating to the base sheet. Prior art paper coatings need binder anywhere from 5 parts (dry parts binder on 100 dry parts of total of pigments) to all the way up to 50 parts, depending on the type of pigment, type of printing application, and type of end use application.

Pigment formulations are expressed in terms of dry parts, with the total dry parts of pigment in a given formulation always equal to 100. Other coating components (including binders and functional additives) are expressed in parts as a ratio to 100 parts pigment. If a coating is prepared with high surface area pigments like fumed silica and silica gel for ink jet printing application, binder is required in an amount of 50 to 60 parts. Generally, silica gel is an aggregated large particle size pigment with high internal porosity while silica fume is a nanoparticle size pigment with particle size in the range of 5-50 nm.

If the coating is prepared with other pigments (such as clays, natural ground calcium carbonates, calcined clay, precipitated calcium carbonate, and talc), existing coatings require binder in an amount from 5 to 20 parts or above, depending on the printing method and pigment types. When it comes to printing methods, 5 parts binder may be sufficient for coated grades meant for rotogravure printing, while 12 to 20 parts binder may be required for coated grades manufactured for offset printing. Within offset grades, 12 to 16 parts binder may be sufficient for ‘coated papers’ for graphics, while 16 to 20 parts binder may be required for paperboard coated grades for packaging.

However, binders are often costly and can substantially increase the price of the final paper product in which they are utilized.

### DETAILED DESCRIPTION OF THE INVENTION

The present invention provides a self binding mineral pigment having a high surface area and a majority of particles with a particle size of less than 200 nanometers.

The present invention also provides a process for the manufacture of these self binding mineral pigments, wherein the process comprises the sequential steps of obtaining a beneficiated unground mineral composition, dry grinding the mineral composition under conditions of high intensity sufficient to aggregate the particles of the mineral composition, whereby the surface area and particle size of the aggregated particles is increased over the surface area and particle size of the unground mineral composition, and wet milling the aggregated dry ground mineral composition under conditions of high intensity to produce a mineral pigment, whereby the particles of the mineral pigment are substantially increased in surface area and substantially decreased in particle size as compared to the dry ground mineral composition prior to wet milling and wherein the mineral pigment is self binding and can be used in paper coating compositions with little or no binder.

In alternative embodiments, the present invention includes a process for the manufacture of these self binding (or low binder requirement) mineral pigments, wherein the process comprises the sequential steps of obtaining a beneficiated unground mineral composition and wet milling the unground mineral composition under conditions of high intensity to produce a mineral pigment.

In alternative embodiments, the present invention also includes a process for the manufacture of self-binding mineral pigments, wherein the process comprises the sequential steps of obtaining a beneficiated unmilled mineral composition and wet milling the mineral composition under conditions of high intensity to produce a mineral pigment, whereby the particles of the mineral pigment are substantially increased in surface area and substantially decreased in particle size as compared to the starting material, and wherein the mineral pigment is self binding and can be used in paper coating compositions with little or no binder.

In this application, the following terms shall have the indicated definitions:
“nano particle”—a particle having a particle size of less than 200 nanometers.
“conditions of high intensity”—dry grinding and/or wet milling under conditions which produce particles which are substantially increased in surface area and substantially increased (dry grinding) or decreased (wet milling) in particle size as compared to the starting material; also referred to as “intensive” wet and/or dry milling. The grinding or milling parameters which produce “conditions of high intensity” could vary depending on several factors, including the equipment used (i.e. plant scale vs. laboratory scale, batch vs. continuous feed), the feed rate and/or media volume, the speed (often measured as RPM) of the grinding or milling process, and processing time. The precise parameters which produce “conditions of high intensity” are set forth below in the several examples that follow.

In certain embodiments, the process involves the sequential steps of obtaining a beneficiated unmilled mineral composition and intensively wet milling the starting beneficiated unmilled mineral composition. In these embodiments, the intensive wet milling process serves to break apart the particles of the beneficiated unmilled mineral composition laterally (hydrogen bonding) and perpendicularly (covalent bonding) wherein a majority of the particles of the resultant pigment have a particle size of less than 200 nanometers.

In preferred embodiments, the process also involves a step of dry grinding the starting beneficiated unmilled mineral composition, wherein the dry grinding step serves to aggregate the nano-particles as they are produced during grinding to yield an aggregated mineral pigment that provides improved ink jet printability and is increased in surface area and particle size but decreased in light scattering coefficient (when compared to those characteristics of the starting beneficiated unground mineral composition). During dry milling, nano-particles are formed as a results of particle delamination (layer separation along a-b, or lateral, direction) due to shear forces as well as broken down (along c-axis) due to the breakage of the covalent bonds. Thus formed nanoparticles are simultaneously drawn to one another by hydrogen bonding, Van der Waals's forces and/or chemical bonding to form particle aggregates, essentially “clusters” of individual nano particles that are held together by hydrogen bonding, Van der Waals's forces and/or chemical bonding. In these embodiments, the wet milling step serves to break apart the aggregates into a nano particle pigment which further is broken down laterally and perpendicularly wherein a majority of the particles of the resultant pigment have a particle size of less than 200 nanometers.

The ability of the inventive pigment to self-adhere to a substrate is due to both the size of the resultant particles, after having undergone the herein described process, and the surface structure of the particles making up the pigment whereby each particle exhibits specific surface characteristics directly resulting from its method of production, i.e. aggregation followed by breaking. Such an extraordinary effect cannot be achieved by simply concentrating or separating the finest particles from the starting material via high speed centrifugation/classification which has not undergone the process described herein.

The structure of kaolin particles, is primarily one octahedral Al(OH)₃ sheet covalently bonded with one tetrahedral SiO₄ sheet to form a 1:1 layer, whereby adjacent layers are held together primarily by hydrogen bonding between the basal oxygen atoms of the tetrahedral sheet and the hydroxyls of the surface plane of the adjacent octahedral sheet. Many such 1:1 layers, typically 20 to 100, are bonded to form an individual kaolin particle. This chemical structure gives kaolin particles a “platey” appearance (at the microscopic level) such that the thickness of the average particle is orders of magnitude smaller than the length or width of the same particle, akin to a sheet of paper.

Accordingly, when a raw kaolin composition comprising individual kaolin particles is processed to obtain smaller particles of kaolin clay, the means by which the particle size reduction is achieved has an impact on the resulting structure, as evidenced by the surface area of the composition as a whole and the surface chemistry of the individual particles. For platey particles, the majority of the surface area of the particle is on the front and back surfaces. In “breaking” a platey particle into two (or more) smaller particles, a method that breaks the particle parallel to the plane of the front and back surfaces would result in two particles that, combined, have a much higher surface area than that of the same two particles formed by breaking a single platey particle perpendicular to this axis. The “planar” breaking of particles also exposes two new interior surfaces that each has roughly the same cross sectional measurement as the large front and back surfaces of the original particle.

The inventive method is a controlled reduction in particle size that results in a composition comprising kaolin particles that are “broken” in such a way (laterally, or parallel to the plane of the primary particle surface) to effect the “platey” characteristic of a higher total surface area to the composition than would result from other means of particle size reduction. The relatively high surface area of the pigment composition as a whole, plus the particle size of the individual particles, give the pigment its novel self-binding characteristics (i.e. ability to be used in a coating composition with low or no binder). The inventors herein have learned that lateral breakage of kaolin particles can be achieved by a method of controlled particle size reduction from a particle aggregate versus a product that is simply processed from a raw or beneficiated state. Stated differently, it is the process of first aggregating and then milling to reduce particle size that results in a novel pigment which shows an ability to self-bind because of its specific, platey shape (and size) that cannot be reproduced using any of the prior art methods described herein. The platey shape of the kaolin particles is evidenced by particles which have a relatively high surface area for a given particle size, and which are increased in surface area and decreased in particle size as compared to the dry ground mineral composition prior to wet milling

The process of this invention can be further modified to include a step in which the dry ground and wet milled particles are subjected to an acid treatment. In this embodiment, the acid treatment serves to increase the surface area of the wet milled particles over that of the wet milled particles prior to the acid treatment. The process of this invention can be further modified to include acid treatment after dry grinding but before wet milling. If used in the process of this invention, the acid treatment step (which can be either before or after wet milling) is preferably done after dry grinding. The intensive dry milling disrupts the crystalline structure of the kaolin and makes the aluminum in kaolin more susceptible to acid dissolution and leaching. The removal of aluminum from the structure creates nanovoids which increases the surface area of the kaolin. The disruption of the kaolin structure by dry milling can be monitored by X-ray Diffraction, solid state ²⁹Si and ²⁷Al Nuclear Magnetic Resonance Spectroscopy (NMR), Fourier Transform Infrared (FTIR) Spectroscopy and/or thermal techniques such as Differential Thermal Analysis (TGA) and Differential Gravimetric Analysis (DTA). Examples of acids which can be used in the acid treatment are sulfuric, hydrochloric, and nitric acids.

Many of the current ink jet inks are anionic in nature and require a cationic coating surface to fix or immobilize the anionic ink jet ink dyes on the surfaces. However, the conventional paper coatings are anionic in nature and require that the pigments be dispersed using an anionic dispersant. Examples of suitable anionic dispersants are polyacrylates, silicates and phosphates. When an anionically dispersed nanoparticle kaolin slurry processed according to the inventive methods disclosed herein is used in ink jet coating, the addition of a cationic dye fixative to the anionic coating “shocks” the coating with thickening and grit formation.

This invention also relates to the production of a cationic mineral pigment slurry. In order to produce a cationic wet milled (or dry ground and wet milled) nano particle kaolin slurry, the kaolin is dispersed with cationic polymer prior to wet milling. Examples of suitable cationic dispersants are polyamines and polydialkyldiallyl-ammonium halides, such as dimethyldiallyl-ammonium chloride.

The wet milling process of this invention should be carefully controlled to achieve the desired particle size or surface area and slurry solids. The slurry tends to thicken with wet milling due to reduction in particle size and a concomitant increase in surface area. The thickening can be minimized by adding an appropriate amount of dispersant and diluent depending upon the time of wet milling. A longer wet milling time would require more dispersant as well as diluent. Alternatively, an excess of predetermined amount of dispersant can be added before wet milling and, in this case, additional dispersant may not be required during wet milling. The slurry consistency can then be adjusted through a controlled dilution to achieve maximum wet milling.

The conventional fine particle kaolin pigment coatings provide high paper gloss, but these coatings do not provide high color density and sufficient porosity for rapid ink absorption, which can lead to puddling, ink smearing and overall poor print quality. However, we have discovered that either hydrous or calcined kaolin clay, after controlled reduction of particle size, gives high gloss and improves ink drying, image formation (also referred to as image acuity) and color density over the original starting hydrous or calcined kaolin clay.

A typical prior art paper coating composition contains one or more pigments, binders (adhesives), and additives. The type and amount of these components are known to affect the optical, mechanical and fluid absorption characteristics of the composition. A binder is an integral part of the coatings used in the prior art to keep the coating adhered to the coated substrate (such as paper) and to prevent dusting during paper handling and the printing process. Examples of binders include natural materials (such as starches and proteins) and synthetic materials (such as latexes).

The self binding mineral pigments of this invention require no binder, or a very low amount of binder, as compared with prior art coating compositions, depending on the application. The ability of the pigment of this invention to self adhere to the substrate makes our pigment unique in providing interesting properties in addition to minimizing the cost of the coating. The self adhesive property of the pigment according to this invention is believed to have come from its particle size in the nano scale range and the relatively high surface area of the bulk pigment, resulting from the unique shape of individual pigment particles and their resultant unique surface chemical properties. These properties allows the particles to stick to one another as well as onto the substrate with hydrogen bonding, van der Wal's forces, and chemical bonding as described herein.

The present invention is further illustrated by the following examples which are illustrative of certain embodiments designed to teach those of ordinary skill in the art how to practice this invention and to represent the best mode contemplated for practicing this invention.

### Example 1

A high brightness Fine No. 1 clay marketed under the trademark Kaofine 90 by Thiele Kaolin Company is used as the starting material. This product is dry ground continuously at 10 Lb/hr feed rates using a laboratory high-speed attritor (Model HSA-1, Union Process Co., Akron Ohio) at a stirring speed of 1200 RPM with 2400 ml of zirconium silicate media (2.0-2.5 mm beads) and a discharge screen of 0.6 mm (100% open) to produce a high surface area aggregated dry ground kaolin product. An anionic slurry of the dry ground product is prepared at 59.5% solids using sodium polyacrylate as dispersant. The slurry is diluted to nearly 50% solids prior to wet milling. The anionic slurry is wet milled in a circulation type process at various process times using a laboratory high intensity wet milling attritor at stirring speed of 2640 rpm (Model QC100, Union Process Inc., Akron, Ohio). The wet milling process using the QC100 attritor includes loading the milling chamber with media and circulating clay slurry for a certain time (process time). The longer the circulation of clay slurry, the longer is the process time. The milling chamber equipped with a discharge screen of 0.15 mm (100% open) is loaded with 260 ml of 0.4 mm size yttrium stabilized zirconia media. At a given media loading and stirring speed, either increase in process time or reduction in the amount of clay loading would increase the wet milling intensity. The anionic slurry equivalent to 5 pounds dry material is wet milled at either 60, 120 or 180 minutes of process time. The product characteristics for standard unground Kaofine 90, dry ground Kaofine 90 and dry ground+wet milled Kaofine 90 kaolin clays are provided in Table A.

The data in Table A indicate that increases in surface area and particle size due to intensive dry grinding compared to the standard unground Kaofine 90. The data in Table A also show that increases in surface area and decreases in particle size are due to wet milling compared to the starting dry ground material. The surface area increases further with an increase in process time due to further decrease of particle size.

### Example 2

A high brightness Fine No. 1 clay marketed under the trademark Kaofine 90 by Thiele Kaolin Company is used as the starting material. An anionic slurry of this clay is prepared at 70% solids using sodium polyacrylate as dispersant. The slurry is diluted to nearly 50% solids prior to wet milling. The anionic slurry is wet milled in a circulation type process at various process times using a laboratory high intensity wet milling attritor at a stirring speed of 2640 rpm (Model QC100, Union Process Inc., Akron, Ohio). The wet milling process using the QC100 attritor includes loading the milling chamber with media and circulating clay slurry for a certain time (process time). The longer the circulation of clay slurry, the longer is the process time. The milling chamber equipped with a discharge screen of 0.15 mm (100% open) is loaded with 260 ml of 0.4 mm size yttrium stabilized zirconia media. At a given media loading and stirring speed, either increase in process time or reduction in the amount of clay loading would increase the wet milling intensity. The anionic slurry equivalent to 5 pounds dry material is wet milled at either 60, 120 or 180 minutes of process time. The product characteristics before and after wet milling are provided in Table B.

As the wet milling continues, the clay particles are broken down into ultrafine particles and the slurry becomes thick. After a certain length of time, further wet milling is difficult. Additional dispersant is added as needed to facilitate the flow of slurry. Water is used as a second option to facilitate slurry flow. The BET surface area and Sedigraph particle size distribution data provided in Table B indicate that the particle size decreases and the surface area increases with the wet milling process compared to the starting feed material. The surface area increases further with an increase in process time due to further decrease of particle size.

### Example 3

A high surface area aggregated kaolin product is produced following the procedure described in Example 1 by dry grinding the kaolin clay products marketed by Thiele Kaolin Company under the Kaolux trademark as the starting material. An anionic slurry of dry ground Kaolux kaolin clay product is prepared at 59% solids using sodium polyacrylate as dispersant. The slurry is diluted to nearly 50% solids prior to wet milling. By following the procedure of Example 1, the anionic slurry equivalent to 5 pounds dry material is wet milled at either 60 or 120 minutes of process time. The product characteristics for standard unground Kaolux, dry ground Kaolux and dry ground and wet milled Kaolux kaolin clays are provided in Table A.

The data in Table A indicate that increases in surface area and particle size are due to intensive dry grinding compared to the starting unground Kaolux. The data in Table A also show that increases in surface area and decreases in particle size are due to wet milling compared to the starting dry ground material. The surface area increases further with an increase in process time due to further decrease of particle size.

### Example 4

A high brightness hydrous kaolin product marketed under the name KAOLUX by Thiele Kaolin Company under the Kaolux trademark is used as the starting material. An anionic slurry of Kaolux kaolin clay product is prepared at 65% solids using sodium polyacrylate as dispersant. The slurry is diluted to nearly 50% solids prior to wet milling. By following the procedure of Example 2, the anionic slurry equivalent to 5 pounds dry material is wet milled at either 60 or 120 minutes of process time. The product characteristics before and after wet milling are provided in Table B.

The data in Table B indicate that increases in surface area and decreases in particle size are due to wet milling. The surface area increases further with an increase in process time due to further decrease of particle size. At the same process time and clay loading, the wet milled products resulted from a Kaofine 90 kaolin clay feed described in Example 2 are much finer than the wet milled products of a Kaolux kaolin clay feed.

TABLE A

| | | | | | | KAOLUX | | | |
|---|---|---|---|---|---|---|---|---|---|
| | KAOFINE 90 | | | | | | | Dry Ground + | |
| | | Dry | Dry Ground + Wet Milled | | | | Dry | Wet Milled | |
| | Unground | Ground | Product 1 | Product 2 | Product 3 | Unground | Ground | Product 4 | Product 5 |
| Wet milling conditions | | | | | | | | | |
| Process time, min | — | — | 60 | 120 | 180 | — | — | 60 | 120 |
| ¹Clay loading, pounds | — | — | 5.0 | 5.0 | 5.0 | — | — | 5.0 | 5.0 |
| ²Dispersant, % | — | 0.5 | 1.7 | 2.2 | 3.4 | — | 0.5 | 3.4 | 5.7 |
| Product Characteristics | | | | | | | | | |
| Product solids, % | 70.0 | 59.5 | 50.5 | 51.5 | 42 | 65.0 | 59.0 | 50.8 | 51.0 |
| Product slurry pH | 7.0 | 7.0 | 7.0 | 7.2 | 7.2 | 7.0 | 7.0 | 7.2 | 7.2 |
| Brookfield viscosity, cP | 280 | 45 | 1825 | 9100 | — | 250 | 60 | 1500 | 5600 |
| @20 rpm | | | | | | | | | |
| BET surface area, m²/g | 21.2 | 44.5 | 72.9 | 86.4 | 94.5 | 13.5 | 32.5 | 69.5 | 84.0 |
| Particle size | | | | | | | | | |
| % < 5.0 μm | 99.0 | 74.9 | 99.7 | 98.7 | 98.8 | 96.4 | 73.5 | 100.2 | 99.0 |
| % < 2.0 μm | 98.4 | 50.8 | 98.5 | 98.2 | 100 | 77.2 | 43.8 | 98.9 | 98.4 |
| % < 1.0 μm | 97.7 | 40.6 | 98.5 | 98.3 | 99.0 | 57.1 | 27.1 | 98.4 | 98.1 |
| % < 0.5 μm | 91.8 | 32.1 | 97.5 | 97.8 | 98.0 | 33.1 | 13.0 | 93.3 | 95.3 |
| % < 0.25 μm | 62.3 | 19.7 | 84.9 | 91.8 | 91.9 | — | — | 72.1 | 80.3 |
| % < 0.2 μm | 51.6 | 17.2 | 76.8 | 88.7 | 90.4 | 15.0 | 6.6 | 64.8 | 74.2 |

^{1,2}Dry basis,
²Sodium polyacrylate

TABLE B

| | KAOFINE 90 | | | KAOLUX | | |
|---|---|---|---|---|---|---|
| | | Wet Milled | | | Wet Milled | |
| | Original | Product | Product | Original | Product | Product |
| | Unground | 1-1 | 2-1 | Unground | 4-1 | 5-1 |
| Wet milling | | | | | | |
| conditions | | | | | | |
| Process time, min | — | 60 | 120 | — | 60 | 120 |
| ¹Clay loading, pounds | — | 5.0 | 5.0 | — | 5.0 | 5.0 |
| ²Dispersant, % | — | 1.9 | 2.4 | — | 1.9 | 1.9 |
| Product | | | | | | |
| Characteristics | | | | | | |
| Product solids, % | 70.0 | 50.5 | 51.0 | 65.0 | 49.5 | 50.0 |
| Product slurry pH | 7.0 | 7.0 | 7.2 | 7.0 | 7.0 | 7.2 |
| Brookfield viscosity, | 280 | 250 | 1500 | 250 | 870 | 1130 |
| cP @20 rpm | | | | | | |
| BET surface | 21.2 | 32.4 | 44.1 | 13.5 | 30.7 | 42.3 |
| area, m²/g | | | | | | |
| Particle size | | | | | | |
| distribution, Sedigraph | | | | | | |
| % < 5.0 μm | 99.0 | 99.4 | 99.4 | 96.4 | 99.4 | 99.2 |
| % < 2.0 μm | 98.4 | 98.5 | 98.1 | 77.2 | 97.3 | 97.6 |
| % < 1.0 μm | 97.7 | 98.3 | 98.4 | 57.1 | 87.4 | 91.3 |
| % < 0.5 μm | 91.8 | 94.7 | 97.2 | 33.1 | 61.7 | 73.8 |
| % < 0.25 μm | 62.3 | 72.7 | 80.7 | — | 40.3 | 57.1 |
| % < 0.2 μm | 51.6 | 63.9 | 72.7 | 15.0 | 36.9 | 53.0 |

### Example 5

This Example 5 describes the wet milling of a cationically dispersed dry ground clay material.

A cationic slurry of a dry ground Kaofine 90 kaolin clay is used as the starting material. A cationic slurry is prepared at 59% solids using a low molecular weight high charge density poly-diallyldimethylammonium chloride cationic polymer (poly-DADMAC) as a dispersant. The poly-DADMAC marketed under the trademark Nalkat 2020 by Nalco Chemical Company is used. The slurry is diluted to nearly 50% solids prior to wet milling. The cationically dispersed dry ground Kaofine 90 kaolin clay is wet milled by following the procedure of Example 1, except that a cationic polymer is used during the wet milling process to maintain the flow properties. The cationic slurry clay equivalent to 5 pounds dry material is wet milled at 75 minutes of process time. The slurry equivalent to 2.5 pounds dry material is also wet milled at 75 minutes of process time. As the wet milling continues, the clay particles are broken down into ultrafine particles, and the slurry becomes thick. After a certain length of time, further wet milling is difficult. Additional cationic polymer is added as necessary as dispersant to facilitate slurry flow. Water is used as a second option to facilitate slurry flow.

The wet milling of cationic dispersed material is difficult relative to the anionic dispersion described in Examples 1-4. Upon addition of extra cationic dispersant, the slurry experiences a momentary pigment shock and immediately requires some dilution water during the wet milling process. The product characteristics before and after wet milling are provided in Table C.

The data in Table C indicate that increases in surface area and decreases in particle size are due to wet milling. The particle size data show that %<0.2 microns increases from 12.9 (dry ground material) up to 95.0 depending on the intensity of the wet milling.

### Example 6

By following the procedure of Example 5, the cationic dry ground Kaofine 90 kaolin clay slurry equivalent to 5 pounds dry material is wet milled at different process times (10, 20, 30, 40, 50 or 60 minutes), except that the total amount of dispersant required for wet milling is added in the beginning of the process. In other words, the feed material is mixed with an excess amount of cationic dispersant (over dispersion) prior to the wet milling process. The product characteristics before and after wet milling are provided in Table D.

The data in Table D indicate that increases in surface area and decreases in particle size are due to wet milling compared with the starting original material. The particle size data in Table D show that %<0.2 microns increases from 12.9 (dry ground material) to 59.9 after 10 minutes of wet milling, 71.2 after 20 minutes of wet milling, 78.4 after 30 minutes of wet milling and 87.4-88.5 after 40-60 minutes of wet milling. The particle size data for the product produced at 40-60 minutes of process time are similar to the 75 minute products described in Example 5. The ease of the wet milling process for a cationic slurry is improved due to the addition of an excess amount of cationic dispersant to the feed (over dispersion), rather than the addition of an excess amount during the wet milling process as in Example 5.

This Example 6 demonstrates that the over dispersion of feed helps to maintain high product solids, reduces process time and increases throughput (the amount of material generated per hour). This Example 6 also demonstrates that the final product quality can be carefully controlled by process time, product solids and the point of dispersant addition.

TABLE C

| | KAOFINE 90, Cationic Dispersion | | |
|---|---|---|---|
| | | Dry Ground + Wet Milled | |
| | Dry Ground | Product 6 | Product 7 |
| Wet milling conditions | | | |
| Process time, min | — | 75 | 75 |
| ¹Clay loading, pounds | — | 5.0 | 2.5 |
| ²Dispersant, % | 1.6 | 6.0 | 6.0 |
| Product Characteristics | | | |
| Slurry solids, % | 59.0 | 35.5 | 26.7 |
| Slurry pH | 4.8 | 4.9 | 4.8 |
| Brookfield viscosity, | 600 | 3150 | 1320 |
| cP @ 20 rpm | | | |
| BET surface area, m²/g | 41.5 | 98.6 | 102.3 |
| Particle size | | | |
| % < 5.0 μm | 76.2 | 98.9 | 99.1 |
| % < 2.0 μm | 45.1 | 98.0 | 98.2 |
| % < 1.0 μm | 30.8 | 98.8 | 98.4 |
| % < 0.5 μm | 23.3 | 97.3 | 98.3 |
| % < 0.25 μm | 15.5 | 92.3 | 97.1 |
| % < 0.2 μm | 12.9 | 88.5 | 95.0 |

^{1,2}Dry basis,
²Poly-DADMAC

TABLE D

| | KAOFINE 90, Cationic Dispersion | | | | | | |
|---|---|---|---|---|---|---|---|
| | | Dry Ground + Wet Milled | | | | | |
| | Dry | Product | Product | Product | Product | Product | Product |
| | Ground | 8 | 9 | 10 | 11 | 12 | 13 |
| Wet milling | | | | | | | |
| conditions | | | | | | | |
| Process time, | — | 10 | 20 | 30 | 40 | 50 | 60 |
| min | | | | | | | |
| ¹Clay loading, | — | 5.0 | 5.0 | 5.0 | 5.0 | 5.0 | 5.0 |
| rounds | | | | | | | |
| ²Dispersant, % | 1.6 | 4.0 | 4.0 | 4.7 | 4.7 | 6.0 | 6.0 |
| Product | | | | | | | |
| Characteristics | | | | | | | |
| Product | 59.0 | 46.9 | 44.0 | 40.0 | 38.3 | 37.0 | 37.0 |
| solids, % | | | | | | | |
| Product slurry | 4.8 | 4.9 | 4.9 | 4.9 | 4.9 | 4.9 | 4.8 |
| pH | | | | | | | |
| Brookfield | 600 | 2290 | 2260 | 4000 | 4100 | 2700 | 3200 |
| viscosity, cP | | | | | | | |
| @20 rpm | | | | | | | |
| BET surface | 41.5 | 51.2 | 57.3 | 60-63.0 | 58.5-68.6 | 58.4-68.2 | 63-67.7 |
| area, m²/g | | | | | | | |
| Particle size | | | | | | | |
| % < 5.0 μm | 76.2 | 99.2 | 99.1 | 99.4 | 99.5 | 98.9 | 99.1 |
| % < 2.0 μm | 45.1 | 97.6 | 98.7 | 98.2 | 98.7 | 98.4 | 97.9 |
| % < 1.0 μm | 30.8 | 94.8 | 97.3 | 97.5 | 98.1 | 98.1 | 97.7 |
| % < 0.5 μm | 23.3 | 84.3 | 90.6 | 94.9 | 96.7 | 97.3 | 96.2 |
| % < 0.25 μm | 15.5 | 66.2 | 76.4 | 84.3 | 90.8 | 91.8 | 91.2 |
| % < 0.2 μm | 12.9 | 59.9 | 71.2 | 78.4 | 87.4 | 88.8 | 87.8 |

^{1,2}Dry basis,
²Poly-DAMAC

### Example 7

The wet milled samples of dry ground Kaofine 90 kaolin clay produced at 60 and 120 minutes process time (products described in Example 1) are evaluated for ink jet coating and printability. The coating formulations, coated sheet properties and ink jet printability data are provided in Table E.

The coating formulations are prepared at around 45% solids and a pH value of 7.0 by adding 3 parts per hundred of ethylene vinyl acetate copolymer latex binder to the pigment slurry. The coating formulation of original material is prepared at 50.2% solids and a pH value of 7.0 by adding 5 parts per hundred of ethylene vinyl acetate binder and 4 parts per hundred poly-DADMAC to the pigment slurry. The coating formulations are applied to a substrate having a basis weight ˜72 g/m², using a laboratory drawdown machine on single side at about 10-11 g/m² coat weight. The coated sheets are dried using a heat gun and conditioned for 24 hours in a constant temperature and humidity room according to standard TAPPI conditions before evaluation. The coated sheets are then soft-nip calendered (1 pass/side, 163 PLI pressure at 300° F. temperature) using a laboratory calender. The conditioned coated sheets are measured for sheet gloss (75 degree gloss) and roughness (Parker Print-Surf roughness) both before and after calendering. The calendered sheets are printed with an in-house print target using Canon BJC 8200 and HP 990cxi printers. The prints are visually observed for ink dry time (time to absorb ink) and image sharpness (visual wicking and bleeding). The print color (cyan, magenta, yellow and black) density is measured using a X-Rite 418 color reflection densitometer.

The coated sheet data in Table E indicate that the roughness, sheet gloss, ink jet color (cyan, magenta, yellow and black) density and dry time are improved for dry ground and wet milled Kaofine 90 kaolin clay compared with the dry ground material. The higher color density indicates that the finer particle size and high surface area are helpful for better hold-out of colorants present in ink jet inks. The sheet gloss increases from 6-8 (dry ground) up to 61 for dry ground and wet milled Kaofine 90 kaolin clay. The sheet gloss of wet milled samples is improved due to decrease in particle size as compared to the much coarser and aggregated particles of original feed. The sheet gloss of 120 minutes product is slightly poorer than 60 minutes product due to cracking of coating film with much finer 120 minutes product. The cracking of coating films is a common phenomenon for nano scale pigment particles such as alumina hydrate used in high gloss ink jet coatings.

TABLE E

| | Anionic KAOFINE 90 | | |
|---|---|---|---|
| | | Dry Ground + Wet Milled | |
| | Dry Ground | Product 1 | Product 2 |
| Coating Formulation | Parts | Parts | Parts |
| Pigment, Parts | 100 | 100 | 100 |
| Ethylene Vinyl Acetate | 5 | 3 | 3 |
| Poly-DADMAC | 4 | 0 | 0 |
| Coating pH | 5.0 | 6.8 | 6.9 |
| Coating Solids, % | 50.2 | 45.0 | 44.6 |
| Brookfield Viscosity, | 320 | 420 | 550 |
| cP @20 rpm | | | |
| Coated sheet Properties | | | |
| Coat weight, gram/m² | 10.9 | 10.4 | 10.4 |
| Gloss | | | |
| Uncalendered | 2-3 | 34.0 | 36.0 |
| ¹Calendered | 6-8 | 61.0 | 58.4 |
| PPS Roughness | | | |
| Uncalendered | 4-5 | 3.62 | 3.31 |
| ¹Calendered | 2.7 | 1.07 | 1.34 |
| Ink Jet Printability | | | |
| Color Density | Canon BJC 8200 Printer | | |
| Cyan | ³1.38 | 1.56 | 1.64 |
| Magenta | 1.28 | 1.34 | 1.38 |
| Yellow | 0.96 | 1.05 | 1.07 |
| Black | 1.28 | 1.30 | 1.32 |
| ²Image Sharpness | 3 | 3 | 3 |
| ²Ink drying | 3 | 2 | 2 |
| Color Density | HP Deskjet 990cxi Printer | | |
| Cyan | 1.28 | 1.37 | 1.49 |
| Magenta | 1.22 | 1.27 | 1.38 |
| Yellow | 0.90 | 0.89 | 0.93 |
| Black | 1.58 | 2.15 | 1.86 |
| ²Image Sharpness | 2 | 2 | 2 |
| ²Ink drying | 2 | 1 | 1 |

¹Soft Nip calendared @ 1 pass/side, 163 PLI at 260° F., PLI = pound per liner inch
²1 = best and 5 = worst

### Example 8

The wet milled sample of cationic dry ground KAOFINE 90 kaolin clay produced at 75 minutes process time as described in Example 5 is evaluated for ink jet coating and printability. The coating formulations, coated sheet properties and ink jet printability data are provided in Table F. The coating formulations are prepared by adding 3 parts per hundred of ethylene vinyl acetate copolymer latex binder to the pigment slurry. The coating formulation of original material is prepared at 50.2% solids and a pH value of 5.0 by adding 5 parts per hundred of ethylene vinyl acetate binder and 4 parts per hundred of poly-DADMAC (total including dispersant amount) to the pigment slurry. The coating formulation of cationic wet milled products are prepared without additional poly-DADMAC. The coatings are applied to a substrate having a basis weight ˜72 g/m² using a laboratory drawdown machine at about 10-11 g/m² coat weight.

The coated sheet data in Table F indicate that the roughness decreases and sheet gloss increases for wet milled Kaofine 90 kaolin clay compared to the starting dry ground material. The sheet gloss increases from 6-8 for dry ground Kaofine 90 kaolin clay up to 56 for wet milled samples. The sheet gloss of wet milled samples is improved due to the decrease in particle size as compared to the much coarser and aggregated particles of dry ground Kaofine 90 kaolin clay feed. The wet milled products are improved in color (cyan, magenta, yellow and black) density and dry time compared with the dry ground kaolin clay feed. The higher color density indicates that the finer particle size and high surface area are helpful for better hold-out of colorants present in ink jet inks. The cationic polymer added in the wet milling acts as a dye-fixing agent and provides improved image sharpness.

This Example 8 demonstrates that the wet milled samples of cationic dry ground Kaofine 90 kaolin clay can be coated with a lower amount of binder, e.g., approximately 40% less binder, than the original material. In addition, this Example 8 demonstrates that the process of the present invention can be used to produce products that are cationic in nature and suitable for high gloss ink jet application.

### Example 9

By following the procedure of Example 8, the wet milled products of cationic dry ground Kaofine 90 kaolin clay produced at different process times (produced at 10, 30, 40, and 50 minutes; products described in Example 6) are evaluated for ink jet coating and printability. The coating formulations, coated sheet properties and ink jet printability data are provided in Table G. Coating formulations are prepared at 37.4-46.2% solids depending on the pigment solids by adding 3-5 parts per hundred of ethylene vinyl acetate binder to the pigment slurry. The coating formulation of original material is prepared at 50.2% solids and a pH value of 5.0 by adding 5 parts per hundred of ethylene acetate binder and 4 parts per hundred of poly-DADMAC to the pigment slurry. The coatings are applied to a substrate having a basis weight ˜72 g/m² using a laboratory drawdown machine at about 10-11 g/m² coat weight.

The coated sheet data provided in Table G indicate that the roughness decreases and sheet gloss increases for wet milled products compared to the dry ground Kaofine 90 kaolin clay feed. The sheet gloss increases from 6-8 for the dry ground Kaofine 90 kaolin clay feed up to 57.5-60 for wet milled products depending on the wet milling process time. The sheet gloss of wet milled samples is improved due to decrease in particle size as compared to the much coarser and aggregated particles of dry ground Kaofine 90 kaolin clay feed. The wet milled products are improved in color (cyan, magenta, yellow and black) density and dry time compared with the dry ground Kaofine 90 kaolin clay feed. The color density is about the same for wet milled samples produced at 30-50 minutes process time, while the wet milled sample produced at 10 minutes process time is lower in color density but improved over the dry ground Kaofine 90 kaolin clay feed. In addition, the color density of wet milled products produced at 30-50 minutes process time is about the same as the 75 minutes products discussed in Example 8. The cationic polymer added in the wet milling acts as a dye-fixing agent and provides improved image sharpness.

This Example 9 demonstrates that throughput from the wet milling unit can be increased by lowering the process time and still produce products that are cationic in nature and suitable for high gloss ink jet application.

### Example 10

A cationic slurry of Kaofine 90 kaolin clay is used as the starting material. A cationic Kaofine 90 kaolin clay slurry is prepared using 1.5% (dry/dry clay basis) of Nalkat 2020 polymer. By following the procedure of Example 5, the cationic Kaofine 90 kaolin clay slurry equivalent to 5 pounds dry material is wet milled at 60 minutes of process time. As the wet milling continues, the clay particles are broken down in to ultrafine particles, and the slurry becomes thick. An additional 2.5% dispersant (Nalkat 2020) is added to facilitate slurry flow. Water is used as a second option to facilitate slurry flow. The product characteristics before and after wet milling are provided in Table H.

The data in Table H indicate that surface area increases and particle size decreases with wet milling. The particle size data show that %<0.2 microns increases from 8.2 (original material) to 85.4 after wet milling.

### Example 11

A calcined kaolin marketed under the trademark Kaocal by Thiele Kaolin Company is used as the starting material. A cationic slurry of Kaocal kaolin clay is prepared using 1.0% (dry/dry clay basis) of Nalkat 2020 polymer. By following the procedure of Example 5, the cationic Kaocal kaolin clay slurry equivalent to 5 pounds dry material is wet milled at 60 minutes of process time. As the wet milling continues, the original low bulk density, high pore volume aggregates of the calcined clay are broken down into fine particles. The wet milling of Kaocal kaolin clay does not require any water or additional dispersant other than what is added during pigment dispersion. The wet milled product is improved in flow properties compared to the original material. The product characteristics before and after wet milling are provided in Table H.

The data in Table H indicate that increases in surface area and decreases in particle size are due to wet milling compared with the original starting material. The particle size data show that %<0.2 microns increases from 8.7 (original material) to 47.7 after wet milling.

TABLE F

| | KAOFINE 90, Cationic Dispersion | | |
|---|---|---|---|
| | | Dry Ground + Wet Milled | |
| | Dry Ground | Product 6 | Product 7 |
| Coating Formulation | Parts | Parts | Parts |
| Clay, Parts | 100 | 100 | 100 |
| Ethylene Vinyl Acetate | 5 | 3 | 3 |
| Poly-DADMAC | 4 | 0 | 0 |
| Coating pH | 5.0 | 4.8 | 5.3 |
| Coating Solids, % | 50.2 | 34.5 | 26.3 |
| Brookfield Viscosity, | 320 | 1268 | 1410 |
| cP @20 rpm | | | |
| Coated sheet Properties | | | |
| Coat weight, gram/m² | 10.9 | 10.7 | 9.8 |
| Gloss | | | |
| Uncalendered | 2-3 | 30.3 | 28.0 |
| ¹Calendered | 6-8 | 54.5 | 56.2 |
| PPS Roughness | | | |
| Uncalendered | 4-5 | 3.12 | 3.8 |
| ¹Calendered | 2.7 | 1.76 | 2.1 |
| Ink Jet Printability | | | |
| Color Density | Canon BJC 8200 Printer | | |
| Cyan | 1.38 | 1.52-1.58 | 1.53 |
| Magenta | 1.28 | 1.37-1.43 | 1.45 |
| Yellow | 0.96 | 1.05-1.08 | 1.07 |
| Black | 1.28 | 1.37-1.43 | 1.44 |
| ²Image Sharpness | 3 | 2 | 2 |
| ²Ink drying | 3 | 2 | 2 |
| Color Density | HP DeskJet 990cxi Printer | | |
| Cyan | 1.28 | 1.55-1.54 | 1.54 |
| Magenta | 1.22 | 1.35-1.40 | 1.50 |
| Yellow | 0.90 | 1.00-1.03 | 1.08 |
| Black | 1.58 | 1.92-1.95 | 1.90 |
| ²Image Sharpness | 2 | 1 | 1 |
| ²Ink drying | 2 | 1 | 1 |

¹Soft Nip calendered @ 1 pass/side, 163 PLI at 260° F., PLI = pound per liner inch
²1 = best and 5 = worst

TABLE G

| | KAOFINE 90, Cationic Dispersion | | | | |
|---|---|---|---|---|---|
| | | Dry Ground + Wet Milled | | | |
| | Dry | Product | Product | Product | Product |
| | Ground | 8 | 10 | 11 | 12 |
| Coating Formulation | Parts | Parts | Parts | Parts | Parts |
| Clay, Parts | 100 | 100 | 100 | 100 | 100 |
| Ehtylene Vinyl Acetate | 5 | 3 | 3 | 5 | 5 |
| Poly-DADMAC | 4 | 0 | 0 | 0 | 0 |
| Coating pH | 5.0 | 5.0 | 5.1 | 4.8 | 4.8 |
| Coating Solids, % | 50.2 | 46.2 | 38.2 | 38.9 | 37.4 |
| Brookfield Viscosity, cP | 320 | 1350 | 1600 | 1630 | 2550 |
| at 20 rpm | | | | | |
| Coated Sheet | | | | | |
| Properties | | | | | |
| Coat weight, gram/m² | 10.9 | 10.2 | 10.4 | 11.2 | 11.0 |
| Gloss | | | | | |
| Uncalendered | 2-3 | 26.8 | 29.8 | 31.8 | 31.2 |
| ¹Calendered | 6-8 | 60.0 | 59.8 | 58.5 | 57.5 |
| PPS Roughness | | | | | |
| Uncalendered | 4-5 | 2.96 | 3.34 | 2.92 | 2.96 |
| ¹Calendered | 2.7 | 1.22 | 1.46 | 1.57 | 1.58 |
| Ink Jet Printability | | | | | |
| Color Density | Canon BJC 8200 Printer | | | | |
| Cyan | 1.38 | 1.57 | 1.59 | 1.60 | 1.57 |
| Magenta | 1.28 | 1.29 | 1.33 | 1.40 | 1.38 |
| Yellow | 0.96 | 1.02 | 1.04 | 1.06 | 1.04 |
| Black | 1.28 | 1.28 | 1.36 | 1.40 | 1.38 |
| ²Image Sharpness | 3 | 4 | 3 | 2 | 2 |
| ²Ink drying | 3 | 4 | 3 | 2 | 2 |
| Color Density | HP DeskJet 990cxi Printer | | | | |
| Cyan | 1.28 | 1.45 | 1.48 | 1.55 | 1.53 |
| Magenta | 1.22 | 1.29 | 1.32 | 1.35 | 1.35 |
| Yellow | 0.90 | 0.94 | 0.95 | 0.99 | 0.99 |
| Black | 1.58 | 1.97 | 1.94 | 1.93 | 1.92 |
| ²Image Sharpness | 2 | 3 | 2 | 1 | 1 |
| ²Ink drying | 2 | 2 | 1.5 | 1 | 1 |

¹Soft Nip calendered @ 1 pass/side, 163 PLI at 260° F., PLI = pound per liner inch
²1 = best and 5 = worst

TABLE H

| | KAOFINE 90, | | KAOCAL, | |
|---|---|---|---|---|
| | Cationic Dispersion | | Cationic Dispersion | |
| | Unground | Wet Milled | Unground | Wet Milled |
| | Original | Product 14 | Original | Product 15 |
| Wet milling conditions | | | | |
| Process time, min | — | 60 | — | 60 |
| ¹Clay loading, pounds | — | 5.0 | — | 5.0 |
| ²Dispersant, % | 1.5 | 4.0 | 1.0 | 1.0 |
| Product | | | | |
| Characteristics | | | | |
| Product solids, % | 55.0 | 40.3 | 50.0 | 51.0 |
| Product slurry pH | 4.7 | 4.2 | 3.5 | 5.0 |
| Brookfield viscosity, cP | 1250 | 2350 | 125 | 65 |
| @20 rpm | | | | |
| BET surface area, m²/g | 20.0 | 36.7 | 18.8 | 27.7 |
| Particle size | | | | |
| % < 5.0 μm | 99.8 | 99.2 | 89.2 | 100.0 |
| % < 2.0 μm | 99.0 | 98.0 | 75.5 | 98.7 |
| % < 1.0 μm | 96.0 | 98.0 | 64.8 | 95.5 |
| % < 0.5 μm | 78.3 | 97.0 | 44.8 | 86.9 |
| % < 0.25 μm | 18.3 | 89.5 | 13.8 | 59.2 |
| % < 0.2 μm | 8.2 | 85.4 | 8.3 | 47.7 |

### Example 12

The wet milled samples of anionic Kaofine 90 kaolin clay produced at 60 and 120 minutes process time (products described in Example 3) are evaluated for ink jet coating and printability. The coating formulations, coated sheet properties and ink jet printability data are provided in Table I.

The coating formulations are prepared at around 45% solids and a pH value of 7.0 by adding 3 parts per hundred of ethylene vinyl acetate copolymer latex binder to the pigment slurry. The coating formulation of original unground product is prepared at 49.5% solids and a pH value of 7.0 by adding 5 parts per hundred of ethylene vinyl acetate binder to the pigment slurry. A cationic coating is required for ink jet application to anchor the ink jet colorants on the surface of the coated sheet for high water fastness property. The coating can be made cationic by either using a cationically dispersed pigment or adding a cationic dye-fixative such as Poly-DADMAC to the coating prepared from an anionically dispersed pigment. However, the wet milled ultrafine anionic slurry products of this invention are not compatible with the cationic dye fixatives (such as Poly-DADMAC) and can result in severe flocculation of the coating color. The coating formulations are applied to a substrate having a basis weight ˜72 g/m², using a laboratory drawdown machine on single side at about 10-11 g/m² coat weight. The coated sheets are dried using a heat gun and conditioned for 24 hours in a constant temperature and humidity room according to standard TAPPI conditions before evaluation. The coated sheets are then soft-nip calendered (1 pass/side, 163 PLI pressure at 300° F. temperature) using a laboratory calender. The conditioned coated sheets are measured for sheet gloss (75 degree gloss) and roughness (Parker Print-Surf roughness) both before and after calendering. The calendered sheets are printed with an in-house print target using Canon BJC 8200 and HP 990cxi printers. The prints are visually observed for ink dry time (time to absorb ink) and image sharpness (visual wicking and bleeding). The print color (cyan, magenta, yellow and black) density is measured using a X-Rite 418 color reflection densitometer.

The coated sheet data in Table I indicate that the ink jet color (cyan, magenta, yellow and black) density and dry time are improved for wet milled Kaofine 90 kaolin clay compared with the original unground material. The higher color density indicates that the finer particle size and high surface area are helpful for better hold-out of colorants present in ink jet inks. The original Kaofine 90 kaolin clay results in an unacceptable image quality; ink in the color print is agglomerated, and a poor image is formed. The after calendered sheet gloss for wet milled products of Kaofine 90 kaolin clay is in the range of 60-63.0 as compared to 65.0 for the original material. The sheet gloss of wet milled products tend to be lower due to less platy nature of the pigment particles as compared to the original material.

This Example 12 demonstrates that the process of this invention can be used to produce products suitable to obtain high coated sheet gloss and ink jet color density. This Example 12 also demonstrates that the products of this invention would require less binder than the original unground material.

TABLE I

| | KAOFINE 90 | | |
|---|---|---|---|
| | | Wet Milled (Anionic) | |
| | Original | Product | Product |
| | Unground | 1-1 | 2-1 |
| Coating Formulation | Parts | Parts | Parts |
| Clay, Parts | 100 | 100 | 100 |
| Ethylene Vinyl Acetate | 5 | 3 | 3 |
| Poly-DADMAC | 0 | 0 | 0 |
| Coating pH | 7.0 | 7.0 | 7.0 |
| Coating Solids, % | 49.5 | 45.1 | 44.6 |
| Brookfield Viscosity, | 90 | 850 | 1350 |
| cP @20 rpm | | | |
| Coated sheet Properties | | | |
| Coat weight, gram/m² | 10.3 | 10.0 | 10.2 |
| Gloss | | | |
| Uncalendered | 30.0 | 39.0 | 37.0 |
| ¹Calendered | 65.4 | 63.0 | 60.0 |
| PPS Roughness | | | |
| Uncalendered | 3.06 | 3.76 | 3.77 |
| ¹Calendered | 0.95 | 1.23 | 1.49 |
| Ink Jet Printability | | | |
| Color Density | Canon BJC 8200 Printer | | |
| Cyan | 1.28 | 1.36 | 1.44 |
| Magenta | 1.03 | 1.10 | 1.18 |
| Yellow | 0.84 | 0.89 | 0.96 |
| Black | 1.02 | 1.07 | 1.17 |
| Image Sharpness | 5 | 4 | 4 |
| ²Ink drying | 5 | 4 | 4 |
| Color Density | HP Deskjet 990cxi Printer | | |
| Cyan | 1.14 | 1.24 | 1.36 |
| Magenta | 0.94 | 1.07 | 1.20 |
| Yellow | 0.72 | 0.82 | 0.89 |
| Black | 2.36 | 1.90 | 1.90 |
| Image Sharpness | 3 | 2 | 2 |
| ²Ink drying | 3 | 2 | 2 |

### Example 13

The wet milled product of cationic Kaofine 90 kaolin clay produced in Example 10 is evaluated for ink jet coating and printability. The coating formulation, coated sheet properties and printability data for unground and wet milled samples are presented in Table J. Coating formulations are prepared by adding 5 parts per hundred of ethylene vinyl acetate binder to the wet milled pigment slurry. The coating formulation of original unground Kaofine 90 kaolin clay feed is prepared by adding 5 parts per hundred ethylene vinyl acetate binder and 4 parts per hundred of poly-DADMAC. The coatings are applied to a substrate having a basis weight ˜72 g/m² using a laboratory drawdown machine on one side at about 10-11 g/m² coat weight.

The coated sheet data provided in Table J indicate that the wet milled product of Kaofine 90 kaolin clay is improved in color (cyan, magenta, yellow and black) density and dry time without substantially degrading the calendered sheet gloss and surface roughness compared with original unground material. The more rounded particles of wet milled product result in a sheet gloss of 60 compared with a sheet gloss of 66 for the original material with platy particles. The original Kaofine 90 kaolin clay material results in high black ink color density but has a very poor color (cyan, magenta and yellow) density and an unacceptable image quality. Ink in the color print is agglomerated, and a poor image is formed.

This Example 13 demonstrates that Kaofine 90 kaolin clay can be used to produce wet milled products that are cationic in nature and suitable for high gloss ink jet application.

### Example 14

The wet milled cationic Kaocal kaolin clay product produced in Example 11 is evaluated for ink jet coating and printability, except that a much stronger binder is required for the original feed material. The coating formulation, coated sheet properties and printability data for original unground and wet milled samples are presented in Table J. A coating formulation of wet milled product is prepared at 51.2% solids by adding 5 parts per hundred of ethylene vinyl acetate binder to the pigment slurry. The coating formulation of original Kaocal kaolin clay feed is prepared at 35% solids by adding 7.5 parts per hundred of high molecular weight polyvinyl alcohol binder and 4 parts poly-DADMAC to the pigment slurry. The coating solids of original Kaocal kaolin clay is lower due to much lower solids of the polyvinyl alcohol binder. The coatings are applied to a substrate having a basis weight ˜72 g/m² using a laboratory drawdown machine on one side at about 10-11 g/m² coat weight. The binder demand for original Kaocal kaolin clay is very high compared to the wet milled Kaocal kaolin clay and causes severe dusting; therefore, a stronger polyvinyl alcohol binder is used.

The wet milled product of cationic Kaocal kaolin clay slurry shows a significant improvement in coated sheet roughness, sheet gloss, ink jet color (cyan, magenta, yellow and black) density and image formation compared with the original unground material (Table J). Although ink dry time is acceptable, the unground material results in very poor ink jet printability in terms of color density and image formation. The wet milling process breaks the original low bulk density, high pore volume and high light scattering aggregates of the calcined clay. The resulting fine particles improve coated sheet gloss and ink jet printability in terms of color density and image formation without substantially changing the dry time (time to dry the ink).

This Example 14 demonstrates that the calcined clay can also be used to produce wet milled products that are cationic in nature and suitable for high gloss ink jet application.

TABLE J

| | KAOFINE 90, Cationic | | KAOCAL, Cationic | |
|---|---|---|---|---|
| | Dispersed | | Dispersed | |
| | Original | Wet Milled | Original | Wet Milled |
| | Unground | Product 14 | Unground | Product 15 |
| Coating Formulation | | | | |
| Clay, Parts | 100 | 100 | 100 | 100 |
| Ethylene Vinyl Acetate | 5 | 5 | — | 5 |
| Polyvinyl Alcohol | — | — | 7.5 | — |
| Poly-DADMAC | 4.0 | — | 4 | — |
| Coating pH | 4.0 | 4.6 | 4.0 | 4.9 |
| Coating Solids, % | 50.0 | 40.5 | 33.5 | 51.2 |
| Brookfield Viscosity, | 1600 | 765 | 450 | 230 |
| cP at 20 rpm | | | | |
| Coated Sheet Properties | | | | |
| Coat weight, gram/m² | 10.9 | 9.9 | 11.0 | 9.9 |
| Gloss, | | | | |
| Uncalendered | 35.4 | 26.7 | 6.0 | 32.0 |
| ¹Calendered | 66.0 | 60.5 | 32.5 | 63.6 |
| PPS Roughness | | | | |
| Uncalendered | 2.2 | 3.8 | 3.9 | 2.84 |
| ¹Calendered | 0.86 | 1.05 | 1.36 | 0.94 |
| Ink Jet Printability | | | | |
| Color Density | Canon BJC 8200 Printer | | | |
| Cyan | 1.38 | 1.52 | 1.21 | 1.43 |
| Magenta | 1.13 | 1.26 | 0.98 | 1.12 |
| Yellow | 0.98 | 1.10 | 0.82 | 0.84 |
| Black | 1.10 | 1.21 | 0.97 | 1.08 |
| ²Image Sharpness | 5 | 2 | 5 | 2 |
| ²Ink drying | 5 | 2 | 1 | 2 |
| Color Density | HP Deskjet 990cxi Printer | | | |
| Cyan | 1.34 | 1.44 | 1.10 | 1.28 |
| Magenta | 1.02 | 1.23 | 0.90 | 1.06 |
| Yellow | 0.78 | 0.95 | 0.70 | 0.75 |
| Black | 1.94 | 1.97 | 1.82 | 2.00 |
| ²Image Sharpness | 5 | 2 | 5 | 2 |
| ²Ink drying | 4 | 2 | 1 | 1.5 |

¹Soft Nip calendered @ 1 pass/side, 163 PLI at 260° F., PLI = pound per liner inch
21 = best and 5 = worst

### Example 15

This Example 15 demonstrates the self binding (binderless) characteristics of the dry ground and wet milled kaolin. By following the procedure of Example 8, the wet milled product of cationic dry ground Kaofine 90 kaolin clay (produced at 75 minutes, Product 6 of Tables F and C) is evaluated for ink jet coating and printability without binder. A coating formulation is also prepared by adding 3 parts per hundred ethylene vinyl acetate binder for comparison. The coated sheets are prepared by directly applying the pigment slurry to a substrate having a basis weight ˜72 g/m² using a laboratory drawdown machine on one side at about 10-11 g/m² coat weight. The coated sheets without binder are evaluated for ink jet printability by following the procedure of Example 8. The coating formulations, coated sheet properties and ink jet printability data are provided in Table K.

The dry ground and wet milled Kaofine 90 kaolin clay pigment coating without a binder adheres strongly to the base paper. The coated sheet strength is evaluated by dry finger rub and tape pull test methods. The coated sheets without binder do not cause any significant dusting, and the strength is sufficient to withstand high calender pressure and to feed through an ink jet printer without any significant problem. Also, the binderless coating resulted in improved ink absorption (Canon printer) and similar sheet gloss and optical density as compared to the sheets prepared using 3 parts of binder.

TABLE K

| | Dry Ground + Wet Milled KAOFINE 90, | |
|---|---|---|
| | Cationic Dispersion, Product 6 | |
| | Without Binder | Using Binder |
| Coating Formulation | | |
| Clay, Parts | 100 | 100 |
| Ethylene Vinyl Acetate | — | 3 |
| Polyvinyl Alcohol | — | — |
| Poly-DADMAC | — | — |
| Coating pH | 5.0 | 4.8 |
| Coating Solids, % | 34.0 | 34.4 |
| Brookfield Viscosity, cP | 2900 | 2650 |
| at 20 rpm | | |
| Coated Sheet Properties | | |
| Coat weight, gram/m² | 10.6 | 10.7 |
| Gloss, | | |
| Uncalendered | 29.0 | 30.3 |
| ¹Calendered | 53.0 | 54.5 |
| PPS Roughness | | |
| Uncalendered | 4.42 | 3.12 |
| ¹Calendered | 1.72 | 1.76 |
| Ink jet Printability | | |
| Cyan | 1.55 | 1.52 |
| Magenta | 1.35 | 1.34 |
| Yellow | 1.00 | 1.01 |
| Black | 1.35 | 1.35 |
| ²Image Sharpness | 1.5 | 2 |
| ²Ink drying | 1.5 | 2 |
| Cyan | 1.47 | 1.49 |
| Magenta | 1.35 | 1.30 |
| Yellow | 0.98 | 0.98 |
| Black | 1.80 | 1.92 |
| ²Image Sharpness | 1 | 1 |
| ²Ink drying | 1 | 1 |

¹Soft Nip calendered @ 1 pass/side, 163 PLI at 260° F., PLI = pound per liner inch
²1 = best and 5 = worst

### Example 16

Example 16 demonstrates that the self binding (binderless) characteristics is unique to the intensively wet milled kaolin with particle size in the nano size range and high surface area of 35 m2/g or higher. Although other examples described herein demonstrate favorable properties for various types of coating applications in varying degrees, one preferred embodiment of the inventive product is that pigment product which demonstrates a surface area of 35 m2/g or higher which demonstrates superior self-binding or low binder characteristics over the remaining examples described herein. Kaolin products produced by simply separating nano size particles through centrifugation do not provide self binding functionality because they have not been processed according to the inventive methods described herein to produce a high surface area product wherein individual particles are aggregated and then wet milled to produce platey “flakes” broken off of the aggregate, resulting in the relatively high surface area shown in Table L.

An anionically dispersed slurry (70% solids) of unground Kaofine 90 kaolin clay was diluted to 25% solids and centrifuged at appropriate G-forces to produce Product 16, Product 17 and Product 18 having particles in the nano size range as tested by Sedigraph such as 60%, 70% and 80%<0.2 microns. The physical characteristics of these products are compared in Table L with the control Kaofine 90 starting material (unground) and the inventive products. As can be seen, although it is possible by known prior art methods, i.e. centrifugation as described herein, to produce a clay pigment product having particle sized in the nano particle range, the pigments produced by these prior art methods also have a much lower surface area than the inventive products because they are not “flaked” from an aggregate via wet milling as described herein to produce a “platey” particle.

Coating formulations are prepared as shown in Table M. The starting Kaofine 90 product coating consists of no binder, 5 parts binder and 10 parts binder while all other coatings contain no binder. The coated sheets are prepared by directly applying the coating to a substrate having a basis weight of 82.5 g/m² using a laboratory drawdown machine on one side at about 8 g/m² coat weight. The coated sheets without binder are evaluated for strength, paper gloss, brightness, and PPS roughness.

The coated sheet strength is evaluated by dry finger rub and tape pull test methods. The inventive wet milled kaolin clay coatings without a binder adhere strongly to the base paper while the Kaofine 90 and the centrifuged Product 14, 15 and 16 coatings dust off upon simply shaking the coated sheet. These coated sheets could not be further processed (calendaring) and tested since the coating dusted off during handling.

The tape pull test for coated sheet strength is conducted as follows: Place a strip of self adhesive tape on coated paper resting on a flat bed and press gently and firmly across the surface of the test area to remove any entrapped air. An unused tape from 3M Brand 600 transparent tape is used for each test. After 30 seconds of time, remove the tape rapidly and approximately perpendicular to the test area. If the coating is strong, resistance to pull is higher. If the coating is weak, resistance to pull is lower. Coating strength is then rated qualitatively, based on the relative differences in resistance to tape pull.

The dry finger rub test for coated sheet strength is conducted as follows: Place dry finger on coated paper resting on a flat bed and rub the sheet (from left to right and right to left several times) on a small area by applying pressure. Similar rubbing pressure and duration is applied for each test using index finger. If the coating is strong enough to stick to the paper, there will not be any dust like material on the finger. Otherwise, dust like material will appear on the dry finger if the coating is weak.

TABLE L

| | Standard | Centrifuged Fine Products | | | Inventive | |
|---|---|---|---|---|---|---|
| | Unground | of Control Product | | | Products | |
| | Kaofine 90 | Product | Product | Product | Product | Product |
| | Control | 16 | 17 | 18 | 1 | 6 |
| Slurry Properties | | | | | | |
| Product solids, % | 70.0 | 70.0 | 70.0 | 70.0 | 50.5 | 35 |
| Product slurry pH | 7.0 | 7.0 | 7.0 | 7.0 | 7.0 | 4.9 |
| Pigment | | | | | | |
| Characterization | | | | | | |
| BET surface area, m²/g | 21.2 | 22.6 | 24.8 | 27.5 | 72.9 | 98.6 |
| Particle size distribution, | | | | | | |
| Sedigraph Method | | | | | | |
| % < 5.0 μm | 99.0 | 100 | 100 | 100 | 99.7 | 98.9 |
| % < 2.0 μm | 98.4 | 100 | 100 | 100 | 98.5 | 98.0 |
| % < 1.0 μm | 97.7 | 100 | 100 | 100 | 98.5 | 98.8 |
| % < 0.5 μm | 91.8 | 96.8 | 98.6 | 99.1 | 97.5 | 97.3 |
| % < 0.25 μm | 62.3 | 70.6 | 79.4 | 86.1 | 84.9 | 92.3 |
| % < 0.2 μm | 51.6 | 60.2 | 69.5 | 77.4 | 76.8 | 88.5 |

However, the inventive product coatings without binder do not cause any significant dusting, and the strength is sufficient to withstand high calender pressure, allowing further paper property testing. The strength of the inventive product coatings are either similar to or improved over the Kaofine 90 coating prepared using 5 parts latex binder as shown in Table M.

TABLE M

| | | | | Centrifuged Fine Products of | | | | |
|---|---|---|---|---|---|---|---|---|
| | Standard Unground | | | Control Product | | | Inventive Products | |
| | Kaofine 90 | | | Product | Product | Product | Product | Product |
| | Control | | | 16 | 17 | 18 | 1 | 6 |
| Coating Formulation | | | | | | | | |
| Clay, Parts | 100 | 100 | 100 | 100 | 100 | 100 | 100 | 100 |
| Styron 620 latex binder, Parts | 10 | 5 | 0 | 0 | 0 | 0 | 0 | 0 |
| per hundred | | | | | | | | |
| Coating Properties | | | | | | | | |
| Coating pH | 7.0 | 7.0 | 6.6 | 6.9 | 6.8 | 6.9 | 7.2 | 4.6 |
| Coating Solids, % | 65 | 65 | 65 | 65 | 65 | 65 | 41.9 | 28.0 |
| Coated sheet Results | | | | | | | | |
| Coat weight, gram/m² | 8.3 | 8.3 | 8.3 | 8.1 | 8.1 | 8.1 | 8.3 | 8.3 |
| ⁽¹⁾Visual observation while | — | — | Dusting | Dusting | Dusting | Dusting | — | — |
| coating | | | | | | | | |
| Coating Strength by Adhesive | 1.0 | 2.0 | ** | ** | ** | ** | 1.5 | 1.5 |
| Tape Pull Test Method | | | | | | | | |
| ^{(2,3)}Qualitative Rating | | | | | | | | |
| ⁽³⁾PPS Roughness | 1.04 | 1.03 | ** | ** | ** | ** | 1.68 | 1.48 |
| ⁽³⁾Paper Gloss | 71 | 71 | ** | ** | ** | ** | 60 | 62 |
| ⁽³⁾Paper Brightness (ISO) | 83.3 | 82.5 | ** | ** | ** | ** | 81.0 | 83.4 |

⁽¹⁾The applied coating film do not stick to the paper once it is dried and dust off of the paper by simply shaking. As a result, it was difficult to handle the sheets and process them further for evaluation.
⁽²⁾1 = best and 5 = worst;
⁽³⁾Calendered sheets were evaluated for paper properties
**Coatings too weak to test due to dusting

This invention has been described in detail with particular reference to certain embodiments, but variations and modifications can be made without departing from the spirit and scope of the invention.

1. A self binding nano particle mineral pigment having an increased surface area wherein the pigment is produced by a process comprising the sequential steps of:
A. obtaining a beneficiated mineral composition; and
B. wet milling the beneficiated mineral composition under conditions of high intensity to produce a mineral pigment,
whereby a majority of particles of the wet milled mineral pigment have a particle size of less than 200 nanometers and the particles of the mineral pigment are increased in surface area and decreased in particle size as compared to the dry ground mineral composition prior to wet milling.

2. The self binding nano particle mineral pigment as defined by claim 1 wherein the beneficiated mineral composition is selected from the group consisting of hydrous kaolin clay, calcined kaolin clay, natural calcium carbonate, calcium sulfate, aluminum hydroxide, iron hydroxide, bentonite, zeolite and mixtures thereof.

3. The self binding nano particle mineral pigment as defined by claim 1 wherein, prior to wet milling, the mineral composition is subjected to dry grinding under conditions of high intensity sufficient to aggregate the particles of the ground mineral composition, whereby the surface area and particle size of the aggregated particles is increased over the surface area of the particles of the unground mineral composition, and whereby the particles of the mineral pigment each exhibit the surface characteristics of a portion of the broken aggregate of ground particles.

4. The nano particle mineral pigment as defined by claim 3 wherein, subsequent to dry grinding but prior to wet milling, the mineral composition is subjected to an acid treatment.

5. The nano particle mineral pigment as defined by claim 3 wherein the dry ground and wet milled mineral composition is subjected to an acid treatment.

6. The nano particle mineral pigment as defined by claim 1 wherein the mineral pigment is self binding and can be used in paper coating applications without the use of a binder.

7. The nano particle mineral pigment as defined by claim 3 wherein the mineral pigment is self binding and can be used in paper coating applications without the use of a binder.

8. The nano particle mineral pigment as defined by claim 5 wherein the mineral pigment is self binding and can be used in paper coating applications without the use of a binder.

9. The nano particle mineral pigment as defined by claim 1 wherein at least 40% of the particles have a particle size of less than 200 nanometers.

10. The nano particle mineral pigment as defined by claim 1 wherein the BET surface area of the pigment is at least 35 m²/g.

11. A paper product coated with a composition which contains a self binding nano particle mineral pigment as defined by claim 1.

12. The paper product of claim 11 wherein said paper product is a glossy coated paper product suitable for use in ink jet printing applications.

13. The paper product of claim 11 wherein the composition does not contain a binder.

14. An ink jet paper coating composition which contains a self binding nano particle mineral pigment as defined by claim 1.

15. The ink jet paper coating composition of claim 14 wherein said paper coating composition does not include a binder.
